(19) United States
(12) Patent Application Publication
(10) Pub. No.: US 2007/0147543 A1
(43) Pub. Date: Jun. 28, 2007

(54) Extension of space-time block code for transmission with more than two transmit antennas

(75) Inventors: Jyh Chau Horng, Saratoga, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/316,723

(22) Filed: Dec. 22, 2005

(51) Int. Cl. H04L 27/00

(52) U.S. Cl. 375/299

(57) ABSTRACT

An STBC encoding extension method for more than two transmit antennas, which provides higher diversity gains while keeping the same coding/decoding latency as in the two-transmit-antenna case of conventional STBC encoding. A N×2 STBC encoder is constructed from a 2×2 STBC encoder, wherein the N×2 STBC encoder is suitable for transmission with higher numbers of transmit antennas including wireless transmission systems with N×1 antenna configurations where N>2.

### FIELD OF THE INVENTION

The present invention relates generally to Space-Time Block Coding for wireless transmission, and in particular to extending Space-Time Block Code for transmission with more than two transmit antennas.

### BACKGROUND OF THE INVENTION

Space-Time Block Coding (STBC) is utilized in wireless communications, such as in MIMO wireless local area networks, to transmit multiple copies of a data stream across a number of antennas. Transmitting multiple copies improves the reliability of data-transfer, providing the receiver a higher probability of being able to use one or more of the received copies of the data to correctly decode the received signal. Space-time coding optimally combines all copies of the received signal to extract maximum information from each copy of the received signal.

STBC can achieve full diversity without knowledge of the channel information at the transmitter. In one example, for consecutive symbols S₁ and S₂, an STBC encoder outputs a 2×2 block matrix such as:

$$[ \begin{matrix}{S}_{1} & - {S}_{2}^{*} \\ {S}_{2} & {S}_{1}^{*}\end{matrix} ] \qquad ( 1 )$$

wherein S is complex and S* is conjugate of S, and elements in the same row are transmitted from the same antenna and each column of elements is transmitted at the same time. For example, at time1 antenna1 transmits S₁ and antenna2 transmits S₂, etc. As shown in relation (1) above, conventional STBC encoding is suitable for two transmit antennas with one spatial data stream. Much effort has been expended to extend conventional STBC encoding into a system with more than two transmit antennas. For example, open-loop approaches focus on extension of STBC without sacrificing the coding rate. Other approaches utilize full/partial CSI (channel state information) feed-backed from the receiver side to further improve the system performance (which becomes closed-loop techniques).

In another approach for high throughput wireless local area network (WLAN) communication, the combination of STBC and antenna selection is proposed for Mₜ-by-1 system configuration, where 2≦Mₜ≦4 wherein Mₜ is the number of transmit antennas. In such an approach, two out of Mₜ antennas are selected for transmission (in a fixed order) for each pair of 2 OFDM symbols in each coding block. Since fixed pattern for antenna selection is used, the complexity for receiver design is simplified and there is no latency increase over the two transmit antenna case. However, the diversity gains are limited over the two transmit antenna case, since the selection pattern is fixed and not changed according to the channel characteristics.

Another open-loop approach extends the coding block in relation (1) above using Walsh expansion to keep the same coding rate, resulting in higher diversity gain as the block size increases. However, this increases coding/decoding latency accordingly since more data symbols are involved within one coding block.

### BRIEF SUMMARY OF THE INVENTION

In one embodiment the present invention provides an STBC encoding extension method which provides higher diversity gains while keeping the same coding/decoding latency as in the two-transmit-antenna case of conventional STBC encoding.

Accordingly, an embodiment of a method of encoding data streams using space-time block coding (STBC) for transmission via Mₜ transmit antennas in a MIMO system, wherein Mₜ>2, comprises the steps of: encoding a plurality of spatial data stream using space-time block code (STBC) encoding to generate multiple encoded data streams; and transmitting each encoded data stream by applying cyclic delay diversity (CDD) per antenna in a group of antennas. Further, the steps of transmitting the encoded data stream includes the steps of applying CDD per antenna in each group of two antennas.

Another embodiment of a method of encoding data streams using space-time block coding (STBC) for transmission via Mₜ transmit antennas in a MIMO system, wherein Mₜ>2, comprises the steps of: encoding a plurality of spatial data stream using space-time block code (STBC) encoding to generate multiple first encoded data streams; encoding each first encoded data stream using STBC encoding to generate multiple second encoded data streams corresponding to that first encoded data stream; and transmitting each second encoded data stream via a transmit antenna.

These and other features, aspects and advantages of the present invention will become understood with reference to the following description, appended claims and accompanying figures.

### BRIEF DESCRIPTION OF THE DRAWINGS

FIG. 1A shows a block diagram of an example of extension of STBC encoding according to an embodiment of the present invention.

FIG. 1B shows a block diagram of another example of extension of STBC encoding according to another embodiment of the present invention.

FIG. 2 shows a block diagram of another example of extension of STBC encoding according to another embodiment of the present invention, equivalent to FIG. 1A for a four transmission antenna example.

FIG. 3 shows a block diagram of another example of extension of STBC encoding according to another embodiment of the present invention, for four transmit antennas by using two-stage STBC encoding.

FIG. 4A shows an example flowchart of the steps of extension of STBC encoding according to an embodiment of the present invention.

FIG. 4B shows an example flowchart of the steps of extension of STBC encoding according to another embodiment of the present invention.

### DETAILED DESCRIPTION OF THE INVENTION

Conventional STBC encoding can achieve full diversity for two transmit antennas with one spatial stream in an open-loop wireless communication system. In such a system, no channel information is available at the transmitter and feedbacks from the receiver side are not necessary. However, in most cases, there are more than two transmit antennas implemented at the transmitter in a wireless communication system. As such, extension of the STBC for higher numbers of transmit antennas is crucial for system with more than two transmit antennas.

The present invention provides an STBC encoding extension method for more than two transmit antennas, and provides higher diversity gains while keeping the same coding/decoding latency as in the two-transmit-antenna case of conventional STBC encoding. In an embodiment of such a method, a Mₜ×2 STBC encoder is constructed from a 2×2 STBC encoder, wherein the Mₜ×2 STBC encoder is suitable for transmission with higher numbers of transmit antennas (i.e., where the number of transmit antennas Mₜ>2). For N×2 STBC encoder, the input is 2 OFDM symbols and output is to Mₜ transmit antennas.

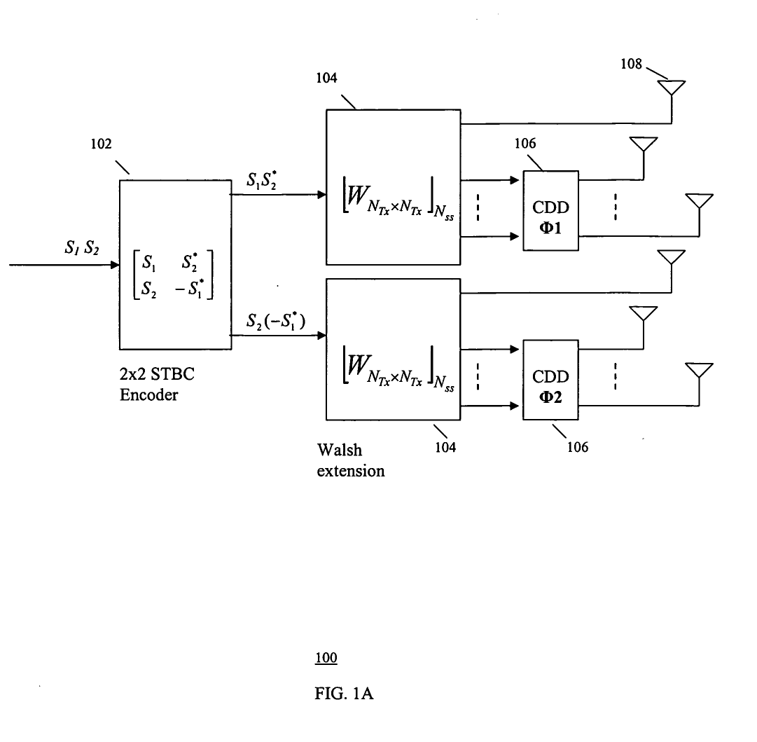

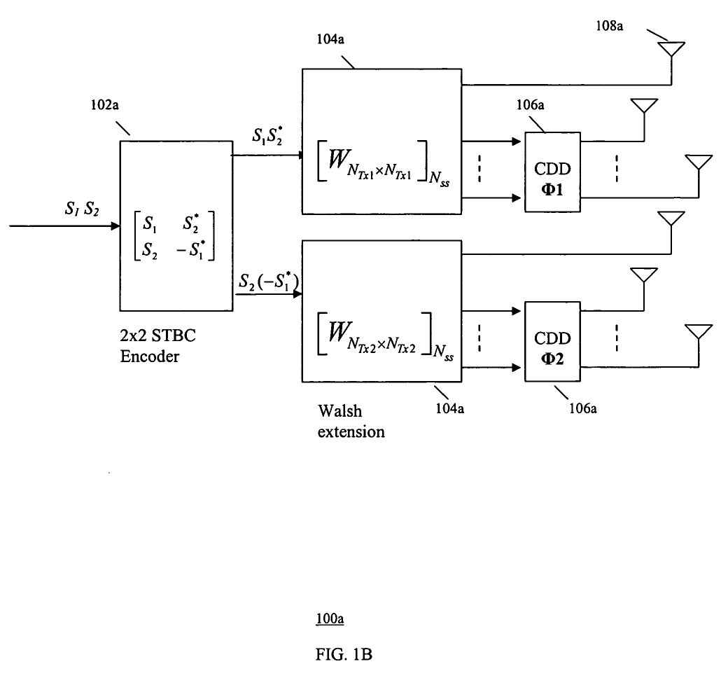

FIG. 1A shows an example of a coding arrangement 100 according to an embodiment of the present invention, to generate a coding block for more than two (e.g., four) transmit antennas. The arrangement 100 includes a 2×2 STBC encoder 102, Walsh extension units 104, cyclic delay diversity (CDD) units 106 and multiple antennas 108. The input data symbols {S₁, S₂} are first STBC coded by the 2×2 STBC encoder 102 to generate the output matrix in relation (1) above, where matrix elements in the same row are output to the same coding path and each column of elements is output at the same time. Since the STBC encoder 102 is a 2×2 encoder, each Walsh extension unit 104 applies a Walsh expansion matrix, W_{N×N}, to each corresponding output stream of unit 102 to map the number of the outputs equal to the number of transmit antennas for that stream. Each CDD unit 106 further applies cyclic delay diversity to the outputs of the corresponding Walsh extension unit 104.

The overall operations of the units 104 and 106 (i.e., Walsh extension and CDD) can be expressed by relation (2) below:
Q^{(k)}=Φ^{(k)}[W_{N}_{_{Tx}}_{×N}_{_{T}}]_{N}_{_{SS}} (2)

wherein the matrix Φ^{(k)} is an N_{Tx}×N_{Tx} diagonal unitary matrix that captures the frequency domain equivalent of cyclic delays in the time domain, N_{Tx}=Mₜ/2 is the number of the transmit antennas in each group that corresponds to each output of unit 102 and Nₛₛ is the number of the spatial streams (In FIG. 1A, Nₛₛ=1, as illustrated in the single input to 2×2 STBC encoder).

In general, the number of transmit antennas in each group does not need to be equal but the total number of transmit antennas must be equal to Mₜ.

FIG. 1B shows another example of a coding arrangement 100a according to another embodiment of the present invention, wherein the total number of transmit antennas Mₜ equals the sum of the number of transmit antenna in group 1 (N_{Tx1}) and the number of transmit antenna in group (N_{Tx2}), such that N_{Tx1} and N_{Tx2} are different. FIG. 1B corresponds to cases wherein the number of transmit antennas N_{Tx} in each group is not equal to each other, but the total number of transmit antennas is equal to Mₜ. The arrangement 100a includes a 2×2 STBC encoder 102a, Walsh extension units 104a, cyclic delay diversity (CDD) units 106a and multiple antennas 108a. The input data symbols {S₁, S₂} are first STBC coded by the 2×2 STBC encoder 102a to generate said output matrix, where matrix elements in the same row are output to the same coding path and each column of elements is output at the same time. Since the STBC encoder 102a is a 2×2 encoder, each Walsh extension unit 104a applies a corresponding Walsh expansion matrix (based on number of transmit antennas in a group) to each corresponding output stream of unit 102a to map the number of the outputs equal to the number of transmit antennas for that stream. Each CDD unit 106a further applies cyclic delay diversity to the outputs of the corresponding Walsh extension unit 104a.

The example in FIG. 1A it is a special case with Mₜ=4, N_{Tx}=4/2=2 and Nₛₛ=1. The notation [A]_{M} shall denote the N×M matrix consisting of the first M columns of an N×N matrix A, where M<=N. Let D denote the per antenna cyclic delay. The delay applied to antenna i_{Tx} is (i_{TX}−1)D. As such, according to an embodiment of the present invention, Φ^{(k)} in relation (2) above can be represented as relation (3) below:
Φ^{(k)}=diag(1,exp(−j2πkΔ_{F}D), . . . , exp(−j2πk(N_{Tx}−1)Δ_{F}D)) (3)

where Φ^{(k}) is a (N_{Tx}×N_{Tx}) diagonal matrix, k is the index of OFDM sub-carrier, and Δ_{F} is bandwidth of each sub-carrier.

The matrix W_{N}_{_{Tx}}_{×N}_{_{Tx}} is the unitary spreading matrix. For N_{Tx}=2 or 4, these are Walsh-Hadamar matrices as represented in relation (4) below:

$${W}_{2 \times 2} = \frac{1}{\sqrt{2}} [ \begin{matrix}+ 1 & + 1 \\ + 1 & - 1\end{matrix} ] and {W}_{4 \times 4} = \frac{1}{2} [ \begin{matrix}+ 1 & + 1 & + 1 & + 1 \\ + 1 & - 1 & + 1 & - 1 \\ + 1 & + 1 & - 1 & - 1 \\ + 1 & - 1 & - 1 & + 1\end{matrix} ] \qquad ( 4 )$$

For N_{Tx}=3 the Fourier matrix in relation (5) below is utilized:

$${W}_{3 \times 3} = \frac{1}{\sqrt{3}} [ \begin{matrix}+ 1 & + 1 & + 1 \\ + 1 & {ⅇ}^{j 2 π / 3} & {ⅇ}^{- j 2 π / 3} \\ + 1 & {ⅇ}^{- j 2 π / 3} & {ⅇ}^{j 2 π / 3}\end{matrix} ] . \qquad ( 5 )$$

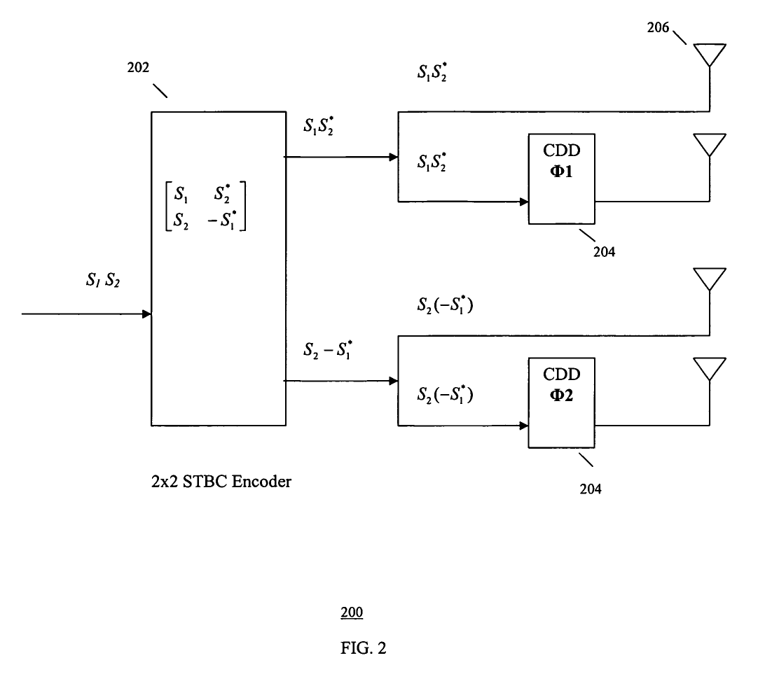

It is noted that when Nₛₛ=1, only the first column of the Walsh expansion matrix in relation (4) is used, resulting in a column vector with identity elements, no matter what the length of the column vector (as seen in relation (4)). For the special case in FIG. 1 with Mₜ=4, N_{Tx}=2 and Nₛₛ=1, the first column of W_{2×2} is utilized to generate the outputs of the Walsh extension units 104. In this case, [W_{2×2}]₁ becomes a unit vector and thus can be eliminated. Those outputs of unit 104 are provided to the CDD unit 106, which includes the first two elements in relation (3) above as N_{Tx}=2. As such, the overall arrangement 100 of FIG. 1A can be represented by the example arrangement 200 in FIG. 2 according to another embodiment of the present invention, wherein the arrangement 200 includes a 2×2 STBC encoder 202, CDD units 204 and the transmit antennas 206.

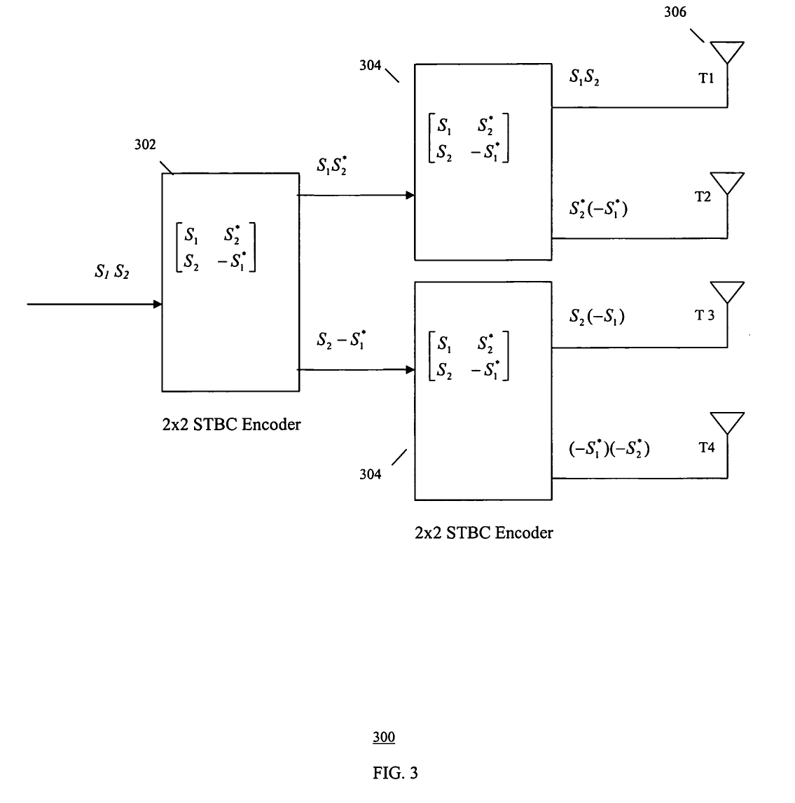

FIG. 3 shows another example arrangement 300 according to another embodiment of the present invention. The arrangement 300 includes a first level STBC encoder 302, second level STBC encoders 304, and antennas 306. The arrangement 300 implements another approach to extend 2×2 STBC to larger numbers of transmission antennas. Again, the data symbols {S₁, S₂} are first STBC coded using the STBC encoder 302 to generate the matrix output of relation (1) above. Each output stream is considered as the input to the STBC coding encoders 304, providing an overall coding block below in relation (6):

$$\begin{matrix} & & Time \\ & & \to \\ Antenna & ↓ & [ \begin{matrix}{S}_{1} & {S}_{2} \\ {S}_{2}^{*} & - {S}_{1}^{*} \\ {S}_{2} & - {S}_{1} \\ - {S}_{1}^{*} & - {S}_{2}^{*}\end{matrix} ]\end{matrix} \qquad ( 6 )$$

Compared with the arrangement 200 in FIG. 2, in the arrangement 300 of FIG. 3 there are no interferences within each sub-group of transmit antennas, (T1,T2) and (T3,T4) as each sub-group in FIG. 3 undergoes a 2×2 STBC operation and in FIG. 2, it only undergoes CDD. The coding depth is kept as 2 symbols and therefore the encoding/decoding latency is improved over conventional approaches. A linear MMSE receiver is necessary for symbol detection.

For 4 transmit antenna case, the number of stages needed is 2. For 8 transmit antennas, the number of stages needed is 3. For other cases where the number of transmit antennas is not an exponent of 2, the approach of FIG. 1A or FIG. 1B is preferred.

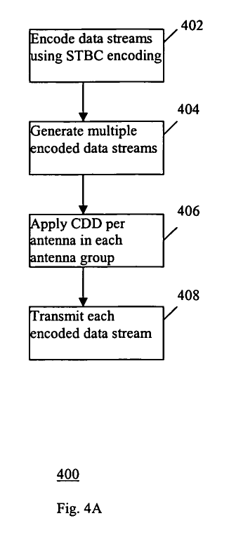

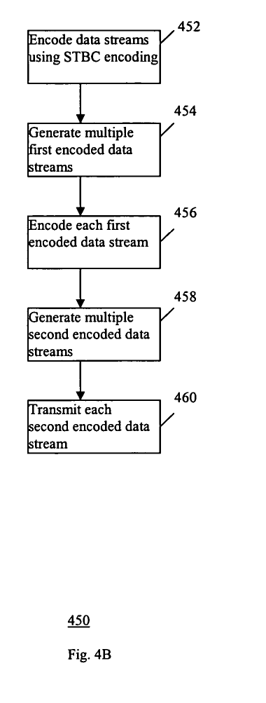

FIG. 4A shows an example flowchart 400 of the steps of an embodiment of the present invention for STBC encoding extension that provides higher diversity gains while keeping the same coding/decoding latency as in the two-transmit-antenna case of conventional STBC encoding. The method in FIG. 4A encodes data streams using space-time block coding (STBC) for transmission via Mₜ transmit antennas in a MIMO system, wherein Mₜ>2, comprising the steps of: encoding a plurality of spatial data streams using space-time block code (STBC) encoding (step 402), generating multiple encoded data streams (step 404), applying cyclic delay diversity (CDD) per antenna in a group of antennas (step 406) and transmitting each encoded data stream (step 408).

FIG. 4B shows another example flowchart 450 of the steps of encoding data streams using space-time block coding (STBC) for transmission via Mₜ transmit antennas in a MIMO system, wherein Mₜ>2, comprising the steps of: encoding a plurality of spatial data stream using space-time block code (STBC) encoding (step 452), generating multiple first encoded data streams (step 454), encoding each first encoded data stream using STBC encoding (step 456), generating multiple second encoded data streams corresponding to that first encoded data stream (step 458), and transmitting each second encoded data stream via a transmit antenna (step 460).

The present invention provides higher diversity gains over the two transmit antennas case, and has the same coding/decoding latency as in the two transmit antennas case.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of encoding data streams using space-time block coding (STBC) for transmission via Mₜ transmit antennas in a MIMO system, wherein Mₜ>2, comprising the steps of:
encoding a plurality of spatial data stream using space-time block code (STBC) encoding to generate multiple encoded data streams; and
transmitting each encoded data stream by applying cyclic delay diversity (CDD) per antenna in a group of antennas.

2. The method of claim 1, wherein the steps of transmitting the encoded data stream further includes the steps of applying CDD per antenna in each group of two antennas.

3. The method of claim 1 wherein:
the steps of encoding each spatial data stream further includes the steps of encoding a data stream using 2×2 STBC encoding to generate multiple encoded data streams; and
the steps of transmitting each encoded data stream further includes the steps of applying CDD per antenna in each group of two antennas, thereby providing Mₜ×2 STBC encoding.

4. The method of claim 1 wherein the delay applied to each antenna i_{Tx} is (i_{Tx}−1)D, wherein D is the per antenna cyclic delay.

5. The method of claim 4, wherein:
the encoded data streams are presented by an N_{Tx}×Nₛₛ matrix W_{N}_{_{Tx}}_{×N}_{_{Tx}} comprising the first Nₛₛ columns of unitary spreading N_{Tx}×N_{Tx} matrix, with W_{N}_{_{Tx}}_{×N}_{_{Tx}} as the unitary spreading matrix, where N_{Tx}=Mₜ/2 is the number of the transmit antennas in each group of antennas, and Nₛₛ is the number of the spatial data streams;
the step of transmitting each encoded data stream further includes the steps of applying CDD as a function of Φ^{(k)} representing an N_{Tx}×N_{Tx} diagonal unitary matrix that captures the frequency domain equivalent of cyclic delays in the time domain, such that:
Φ^{(k)}=diag (1,exp(−j2πkΔ_{F}D), . . . , exp(−j2πk(N_{Tx}−1)Δ_{F}D)).

6. The method of claim 1 wherein the step of encoding further includes the steps of encoding consecutive symbols S₁ and S₂ into block matrix:
$$[ \begin{matrix}{S}_{1} & - {S}_{2}^{*} \\ {S}_{2} & {S}_{1}^{*}\end{matrix} ] .$$

7. A method of encoding data streams using space-time block coding (STBC) for transmission via Mₜ transmit antennas in a MIMO system, wherein Mₜ>2, comprising the steps of:
(a) encoding a plurality of spatial data stream using space-time block code (STBC) encoding to generate multiple first encoded data streams;
(b) encoding each first encoded data stream using STBC encoding to generate multiple second encoded data streams corresponding to that first encoded data stream; and
(c) transmitting each second encoded data stream via a transmit antenna.

8. The method of claim 7 wherein in step (a), STBC encoding further includes the steps of encoding consecutive symbols S₁ and S₂ into block matrix:
$$[ \begin{matrix}{S}_{1} & - {S}_{2}^{*} \\ {S}_{2} & {S}_{1}^{*}\end{matrix} ] .$$

9. The method of claim 7 wherein in step (b), STBC encoding further includes the steps of encoding consecutive symbols S₁ and S₂ into block matrix:
$$[ \begin{matrix}{S}_{1} & - {S}_{2}^{*} \\ {S}_{2} & {S}_{1}^{*}\end{matrix} ] .$$

10. The method of claim 7 wherein in both steps (a) and (b), STBC encoding generates an overall coding block
$$matrix \text{:} [ \begin{matrix}{S}_{1} & {S}_{2} \\ {S}_{2}^{*} & - {S}_{1}^{*} \\ {S}_{2} & - {S}_{1} \\ - {S}_{1}^{*} & - {S}_{2}^{*}\end{matrix} ] .$$

11. A method of encoding data streams using space-time block coding (STBC) for transmission via Mₜ transmit antennas in a MIMO system, wherein Mₜ>2, comprising the steps of:
encoding a plurality of spatial data stream using space-time block code (STBC) encoding to generate multiple encoded data streams; and
transmitting each encoded data stream by applying cyclic delay diversity (CDD) per antenna in a group of antennas;
wherein the number of transmit antennas N_{Tx} in each of two or more groups are different, but the total number of transmit antennas is equal to Mₜ.

12. The method of claim 11, wherein the steps of transmitting the encoded data stream further includes the steps of applying CDD per antenna in each group of two antennas.

13. The method of claim 11 wherein:
the steps of encoding each spatial data stream further includes the steps of encoding a data stream using 2×2 STBC encoding to generate multiple encoded data streams; and
the steps of transmitting each encoded data stream further includes the steps of applying CDD per antenna in each group of two antennas, thereby providing Mₜ×2 STBC encoding.

14. The method of claim 11 wherein the delay applied to each antenna i_{Tx} is (i_{Tx}−1)D, wherein D is the per antenna cyclic delay.

15. The method of claim 14, wherein:
the encoded data streams are presented by an N_{Tx}×Nₛₛ matrix W_{N}_{_{Tx}}_{×N}_{_{Tx}} comprising the first Nₛₛ columns of unitary spreading N_{Tx}×N_{Tx} wherein, with matrix W_{N}_{_{Tx}}_{×N}_{_{Tx}} as the unitary spreading matrix, where N_{Tx} is the number of the transmit antennas in each group of antennas, and Nₛₛ is the number of the spatial data streams;
the step of transmitting each encoded data stream further includes the steps of applying CDD as a function of Φ^{(k)} representing an N_{Tx}×N_{Tx} diagonal unitary matrix that captures the frequency domain equivalent of cyclic delays in the time domain, such that:
Φ^{(k)}=diag(1,exp(−j2πkΔ_{F}D), . . . , exp(−j2πk(N_{Tx}−1)Δ_{F}D)).

16. The method of claim 11 wherein the step of encoding further includes the steps of encoding consecutive symbols S₁ and S₂ into block matrix:
$$[ \begin{matrix}{S}_{1} & - {S}_{2}^{*} \\ {S}_{2} & {S}_{1}^{*}\end{matrix} ] .$$

17. A method of encoding data streams using space-time block coding (STBC) for transmission via Mₜ transmit antennas in a MIMO system, wherein Mₜ>2, comprising the steps of:
encoding a plurality of spatial data stream using space-time block code (STBC) encoding to generate multiple encoded data streams;
performing Walsh extension by applying a Walsh expansion matrix to each corresponding encoded data stream to map the number of the outputs equal to the number of transmit antennas for that stream; and
transmitting each encoded data stream by applying cyclic delay diversity (CDD) per antenna in a group of antennas.

18. The method of claim 17 wherein the delay applied to each antenna i_{Tx} is (i_{Tx}−1)D, wherein D is the per antenna cyclic delay.

19. The method of claim 18, wherein:
the encoded data streams are presented by an N_{Tx}×Nₛₛ matrix W_{N}_{_{Tx}}_{×N}_{_{Tx}} comprising the first Nₛₛ columns of unitary spreading N_{Tx}×N_{Tx} wherein, with matrix W_{N}_{_{Tx}}_{×N}_{_{Tx}} as the unitary spreading matrix, where N_{Tx} is the number of the transmit antennas in each group of antennas, and Nₛₛ is the number of the spatial data streams;
the step of transmitting each encoded data stream further includes the steps of applying CDD as a function of Φ^{(k)} representing an N_{Tx}×N_{Tx} diagonal unitary matrix that captures the frequency domain equivalent of cyclic delays in the time domain, such that:
Φ^{(k)}=diag(1,exp(−j2πkΔ_{F}D), . . . , exp(−j2πk(N_{Tx}−1)Δ_{F}D)).

20. A method of encoding data streams using space-time block coding (STBC) for transmission via Mₜ transmit antennas in a MIMO system, wherein Mₜ>2, comprising the steps of:
encoding a plurality of spatial data stream using space-time block code (STBC) encoding to generate multiple encoded data streams; and
transmitting each encoded data stream by applying cyclic delay diversity (CDD) per antenna in a group of antennas;
wherein number of transmit antennas Mₜ=4 and number of spatial data streams Nss=1.
